(19) United States
(12) Patent Application Publication
(10) Pub. No.: US 2018/0060419 A1
(43) Pub. Date: Mar. 1, 2018

(54) Generating Prompting Keyword and Establishing Index Relationship

(71) Applicant: Alibaba Group Holding Limited, Grand Cayman (KY)

(72) Inventors: Pengjun XIE, Hangzhou (CN); Qiu Long, Hangzhou (CN); Kang Sun, Hangzhou (CN); Jun Lang, Hangzhou (CN)

(73) Assignee: Alibaba Group Holding Limited

(21) Appl. No.: 15/688,537

(22) Filed: Aug. 28, 2017

(30) Foreign Application Priority Data
Aug. 31, 2016 (CN) 201610797267.7

(51) Int. Cl. G06F 17/30

(52) U.S. Cl. CPC G06F 17/30646; G06F 17/30867

(57) ABSTRACT

An example method for generating a prompting keyword may include receiving a target search keyword sent by a client terminal and determining a target scene keyword corresponding to the target search keyword. The target scene keyword may indicate an application scenario of an object corresponding to the target search keyword. The method may further include obtaining, based on the target scene keyword, a target prompting keyword corresponding to the target scene keyword to ensure to generate target prompting keywords more comprehensive and effectively help users to improve search efficiency.

### CROSS REFERENCE TO RELATED PATENT APPLICATIONS

This application claims priority to Chinese Patent Application No. 201610797267.7, filed on Aug. 31, 2016, entitled “Method, Server, and Client Terminal for Generating Prompting keyword and Establishing Index Relationship,” which is hereby incorporated by reference in its entirety.

### TECHNICAL FIELD

The present disclosure relates to the field of computer application technology, and more particularly, to a method of generating a prompting keyword and establishing an indexing relationship, and a server as well as a client terminal thereof.

### BACKGROUND

With the development of network technology, more and more users are searching for information using search engines. The search engines can retrieve relevant information according to words input by a user and display retrieved related information as a search result to the user. When the user searches for information using a search engine, the user may not get desired search results without right search keywords. To help users build accurate search keywords and to improve search efficiency, many search engines usually recommend prompting keywords to the user.

In conventional techniques, prompting keywords may be provided as follows. Search engines, based on search records, analyze a large number of candidate keywords. After receiving a word input by the user, the search engine may, based on the word, identify candidate keywords containing the word from the analyzed candidate keywords and recommend the identified candidate search keyword as the search keyword to the user.

FIG. 1 is a user interface illustrating prompting keywords according to a conventional technique. As shown in FIG. 1, after receiving the word “baby cart” input by the user, the search engine may find candidate keywords from the analyzed candidate keywords including “baby carts,” “baby carts light folding”, “light baby carts capable of folding and lying”, “baby carts toys” and “baby stroller windshield” etc. and recommend the identified candidate search keyword as the prompting keyword to the user.

In this process, there are some problems. For example, the search engines typically categorize candidate keywords containing words input by the user as prompting keywords to the user. In this way, the prompting keywords recommended by the search engines are usually in words input by the user and other keywords that are identified and added based on the words. These recommended keywords are often limited by the words input by the user. In FIG. 1, for example, the area of the prompting keywords such as “baby carts light folding,” “light baby carts capable of folding and lying,” “baby carts toys” and “baby stroller windshield” etc. are consistent with the word “baby cart” input by the user. They are all in the area of “baby stroller.” Accordingly, the prompting keyword may not be comprehensive and cannot accurately reflect the user's intent. This fails to improve search efficiency for users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Embodiments of the present disclosure relate to a method of generating a prompting keyword, a method of establishing an index relationship, and a server as well as a client terminal thereof. The embodiments of the present disclosure may generate prompting keywords that are more comprehensive and effectively help users to improve search efficiency.

To solve the technical problems described above, the embodiments of the present disclosure provide a method of generating a prompting keyword, a method of establishing an index relationship, and a server as well as a client terminal thereof.

The present disclosure provides a method for generating a prompting keyword comprising:

receiving a target search keyword;

determining a target scene keyword corresponding to the target search keyword, the target scene keyword indicating an application scenario of an object corresponding to the target search keyword; and

obtaining a target prompting keyword corresponding to the target scene keyword based on the target scene keyword.

For example, the determining the target scene keyword corresponding to the target search keyword includes:

calculating a similarity between the target search keyword and one or more candidate scene words in a candidate scene keyword set; and

determining the target scene keyword from the candidate scene keyword set based on the calculated similarity.

For example, the determining the target scene keyword from the candidate scene keyword set based on the calculated similarity includes designating a scene keyword in the candidate scene keyword set having the highest calculated similarity as the target scene keyword.

For example, the obtaining the target prompting keyword corresponding to the target scene keyword includes obtaining the target prompting keyword corresponding to the target scene keyword based on a correspondence relationship between a preset scene keyword and the prompting keyword.

The present disclosure also provides a method for establishing an index relationship comprising:

obtaining at least one search keyword within a first preset time period;

determining a scene keyword based on the at least one search keyword;

determining a prompting keyword corresponding to the scene keyword based on an object information of an object corresponding to the scene keyword; and

establishing a correspondence relationship between the scene keyword and the prompting keyword.

For example, the determining the scene keyword based on the at least one search keyword comprises:

determining one or more categories corresponding to a search keyword in the at least one search keyword;

calculating a number of the one or more categories corresponding to the search keyword of the at least one search keyword; and

selecting a candidate word set from the at least one search keyword based on the number of the one or more categories; and

selecting the scene keyword from the candidate word set.

For example, the selecting the candidate word set from the at least one search keyword includes designating a word set comprising at least one search keyword having the number of categories greater than a predetermined first threshold as the candidate word set.

For example, the selecting the scene keyword from the candidate word set includes:

performing word segmentation on search keywords of the candidate word set;

obtaining one or more segmented phrases corresponding to the search keyword; and

selecting the scene keyword from the candidate word set based on the one or more segmented phrases.

For example, the selecting the scene keyword from the candidate word set based on the one or more segmented phrases comprises:

calculating a frequency of the one or more segmented phrase in the candidate word set respectively; and

selecting the scene keyword from the candidate word set based on the calculated frequency.

For example, the selecting the scene keyword from the candidate word set based on the calculated frequency includes:

calculating an average value of frequencies of the one or more segmented phrases corresponding to one or more search keywords in the candidate word set, and

selecting the search keyword having the average value greater than a preset second threshold from the candidate word set as the scene keyword.

For example, the selecting the scene keyword from the candidate word set based on the calculated frequency includes:

calculating a median value of frequencies of the one or more segmented phrases corresponding to one or more search keywords in the candidate word set, and

selecting the search keyword having the median value greater than a preset third threshold from the candidate word set as the scene keyword.

For example, the selecting the scene keyword from the candidate word set based on the one or more segmented phrases includes:

determining a part of speech of the one or more segmented phrases respectively; and

selecting the scene keyword from the candidate word set based on the part of speech.

For example, the selecting the scene keyword from the candidate word set based on the part of speech includes selecting the search keyword corresponding to a segmented phrase having a verb or a noun in the candidate word set as the scene keyword.

For example, the selecting the scene keyword from the candidate word set includes selecting M search keywords having largest numbers of corresponding categories from the candidate word set as the scene keyword, M being a preset integer greater than zero.

For example, the selecting the scene keyword from the candidate word set includes:

obtaining the number of transactions and the number of queries of a respective search keyword in the candidate word set within a preset second time; and

calculating a transaction conversion rate corresponding to the respective search keyword in the candidate word set, the transaction conversion rate being a ratio between the number of transactions and the number of queries of the respective search keyword; and

selecting the scene keyword from the candidate word set based on the transaction conversion rate.

For example, the selecting the scene keyword from the candidate word set based on the transaction conversion rate includes selecting N search keywords having smallest transaction conversion rates from the candidate word set as the scene keyword, N being a preset integer greater than 0.

For example, the selecting the scene keyword from the candidate word set based on the transaction conversion rate includes selecting the search keyword having transaction conversion rates less than a preset fourth threshold from the candidate word set as the scene keyword.

For example, the determining the prompting keyword corresponding to the scene keyword based on the object information of the object corresponding to the scene keyword includes:

designating a set comprising objects corresponding to the scene keyword as a first object set;

selecting a second object from the first object set; and

determining the prompting keyword corresponding to the scene keyword based on the second object.

For example, the selecting the second object from the first object set includes:

selecting objects having numbers of transactions greater than a preset fifth threshold within a preset third time from the first object set as the second object; or

selecting objects having numbers of being visited greater than a preset sixth threshold within a preset third time from the first object set as the second object.

For example, the determining the prompting keyword corresponding to the scene keyword based on the second object includes:

performing word segmentation on a name of the second object to obtain segmented phrases of the second object; and

selecting a core segmented phrase from the segmented phrases of the name of the second object as the prompting keyword, the core segmented phrase indicating a meaning of the name of the second object.

The present disclosure also provides a method for displaying data of a web page, the method comprising:

receiving a target search keyword;

transmitting the target search keyword to a server; and

displaying web page data returned from the server, the web page data including a target prompting keyword, the target prompting keyword corresponding to a target scene keyword, the target scene keyword indicating an application scenario of an object corresponding to the target search keyword.

The present disclosure also provides a server comprising:

a receiving module configured to receive a target search keyword sent by a client terminal;

a target scene keyword determination module configured to determine a target scene keyword corresponding to the target search keyword, the target scene keyword indicating an application scenario of an object corresponding to the target search keyword; and

a target prompting keyword acquisition module configured to obtain a target prompting keyword corresponding to the target scene keyword based on the target scene keyword.

The present disclosure also provides a server comprising:

a search keyword acquisition module configured to obtain at least one search keyword within a first preset time;

a scenario keyword determination module configured to determine a scene keyword based on the at least one search keyword;

a prompting keyword determination module configured to determine a prompting keyword corresponding to the scene keyword based on an object information of an object corresponding to the scene keyword; and

a corresponding relationship building module configured to establish a correspondence relationship between the scene keyword and the prompting keyword.

The present disclosure also provides a server comprising:

a server communication module configured to perform network data communication; and

a server processor configured to:
receive a target search keyword sent by a client terminal by the server communication module,
determine a target scene keyword corresponding to the target search keyword, and
obtain a target prompting keyword corresponding to the target scene keyword based on the target scene keyword, the target scene keyword indicating an application scenario of an object corresponding to the target search keyword.

The present disclosure also provides a client terminal comprising:

an input device configured to input data;

a client communication module configured to perform network data communication;

a monitor configured to display data; and

a client processor configured to:
receive a target search keyword input by a user via the input device,
transmit the target search keyword to a server via the client communication module,
receive web page data returned from the server through the client communication module, and
control the web page data displayed on the monitor, the web page data including a target prompting keyword, the target prompting keyword corresponding to a target scene keyword, the target scene keyword indicating an application scenario of an object corresponding to the target search keyword.

To solve technical programs of the above, the embodiments herein demonstrate a method of generating a prompting keyword, a method of establishing an index relationship, and a server as well as a client terminal thereof. The embodiments may determine a scene keyword corresponding to the search keyword based on category information of search keywords input by users, generate a prompting keyword based on object information of a related object in a scenario, and then establish a correspondence relationship between the scene keyword and the prompting keyword. The keyword can be a complete coverage of a scene associated with the object. When a user uses the index relationship to index, the target scene keyword may be determined based on the target search keyword input by the user. The prompting keyword may be generated based on the correspondence between a preset scene keyword and the prompting keyword. The embodiments herein may ensure the fullness of the generated keywords and effectively help users improve retrieval efficiency.

### BRIEF DESCRIPTION OF THE DRAWINGS

The detailed description is described with reference to the accompanying figures. Further, the described figures merely represent part of the implementations of the present disclosure. Those skilled in the art should understand that other figures may be obtained in accordance with the implementations of the present disclosure.

FIG. 1 is a user interface illustrating prompting keywords according to a conventional technique.

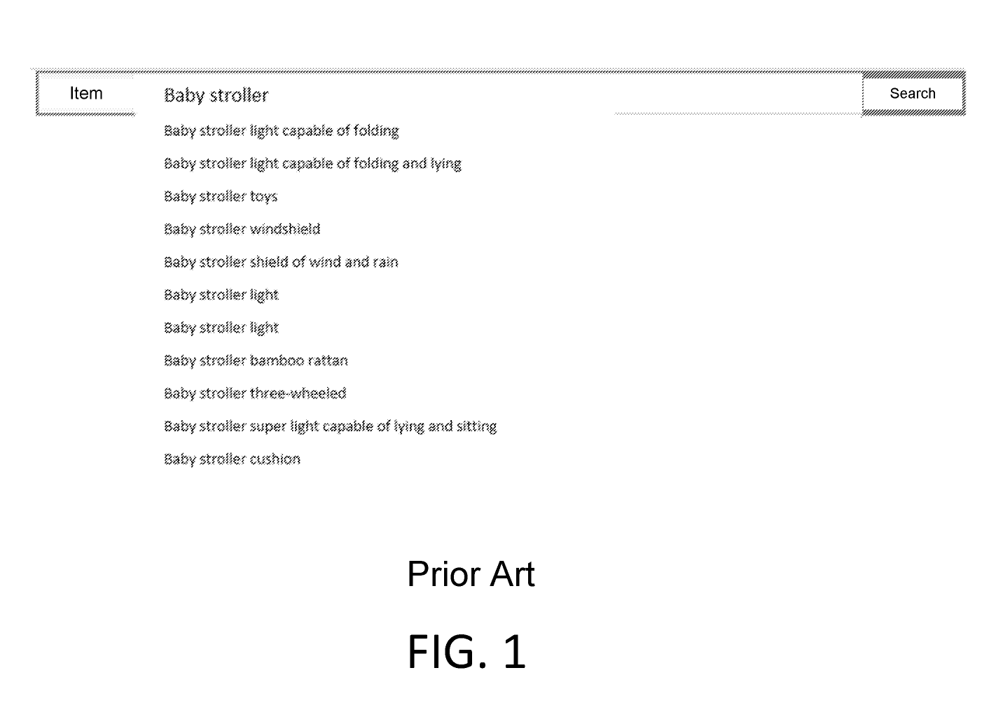

FIG. 2 is a flowchart illustrating a method of establishing an indexing relationship in accordance with embodiments of the present disclosure.

FIG. 3 is a schematic diagram illustrating a category in accordance with embodiments of the present disclosure.

FIG. 4 is a schematic diagram illustrating an index relationship established in accordance with embodiments of the present disclosure.

FIG. 5 is a flowchart illustrating a method of generating a prompting keyword in accordance with embodiments of the present disclosure.

FIG. 6 is a block diagram illustrating a server in accordance with embodiments of the present disclosure.

FIG. 7 is a schematic diagram of a server in accordance with embodiments of the present disclosure.

FIG. 8 is another block diagram illustrating a server in accordance with embodiments of the present disclosure.

FIG. 9 is a schematic diagram of a client terminal in accordance with embodiments of the present disclosure.

### DETAILED DESCRIPTION

To enable those skilled to better understand the application of technical solutions, detailed descriptions are provided as follows in conjunction with the drawings. The described embodiments merely represent part of the embodiments of the present application and not all of the embodiments.

A method of generating prompting keyword may include receiving a target search keyword sent by a client terminal and determining a target scene keyword corresponding to the target search keyword. The target scene keyword may indicate an application scenario of an object corresponding to the target search keyword. The method may further include obtaining a target prompting keyword corresponding to the target scene keyword based on the target scene keyword.

A method of establishing an index relationship may include obtaining at least one search keyword within a first preset period, determining a scene keyword based on the at least one search keyword, determining a prompting keyword corresponding to the scene keyword based on an object information of an object corresponding to the scene keyword, and establishing a correspondence relationship between the scene keyword and the prompting keyword.

A method of displaying data of a web page may include receiving a target search keyword input by a user, transmitting the target search keyword to a server, and displaying web page data returned from the server. The web page data may include a target prompting keyword, and the target prompting keyword may correspond to the target scene keyword. The target scene keyword may indicate an application scenario of an object corresponding to the target search keyword.

A server may include a receiving module configured to receive a target search keyword sent by a client terminal and a target scene keyword determination module configured to determine a target scene keyword corresponding to the target search keyword. The target scene keyword may indicate an application scenario of an object corresponding to the target search keyword. The server may further include a target prompting keyword acquisition module configured to obtain a target prompting keyword corresponding to the target scene keyword based on the target scene keyword.

A server may include a search keyword acquisition module configured to obtain at least one search keyword within a first preset period, a scenario keyword determination module configured to determine a scene keyword based on the at least one search keyword, a prompting keyword determination module configured to determine a prompting keyword corresponding to the scene keyword based on an object information of an object corresponding to the scene keyword, and a corresponding relationship building module configured to establish a correspondence relationship between the scene keyword and the prompting keyword.

A server may include a server communication module configured to perform network data communication and a server processor configured to receive a target search keyword sent by a client terminal by the server communication module, determine a target scene keyword corresponding to the target search keyword, and obtain a target prompting keyword corresponding to the target scene keyword based on the target scene keyword. The target scene keyword may indicate an application scenario of an object corresponding to the target search keyword.

A client terminal may include an input device configured to input data, a client communication module configured to perform network data communication, a monitor configured to display data. The client terminal may further include a client processor configured to receive a target search keyword input by a user via the input device, transmit the target search keyword to a server via the client communication module, receive the web page data returned from the server through the client communication module, and control the web page data displayed on the monitor. The web page data may include a target prompting keyword, the target prompting keyword may correspond to the target scene keyword, and the target scene keyword may indicate an application scenario of an object corresponding to the target search keyword.

The method of generating a prompting keyword in the present embodiment may provide various services to users and display retrieved related information as a search result with respect to the user's search engine. The search engine may include a general search engine and a vertical search engine. The generic search engine may typically extract information from various web pages from the Internet to create a database. After receiving the user's index or search conditions, the relevant information may be retrieved from the database based on the index or search conditions provided by the user and display the retrieved related information as a search result to the user. For example, the search engine may include Google, Baidu and so on. The vertical search engine may typically provide a retrieval service for a particular domain, a specific population, or a specific demand and display the retrieved related information as a search result to the user. For example, such services may include picture searches provided by Baidu and item searches provided by Taobao™, etc.

Below in conjunction with the accompanying drawings, the embodiments of the present disclosure are described in detail.

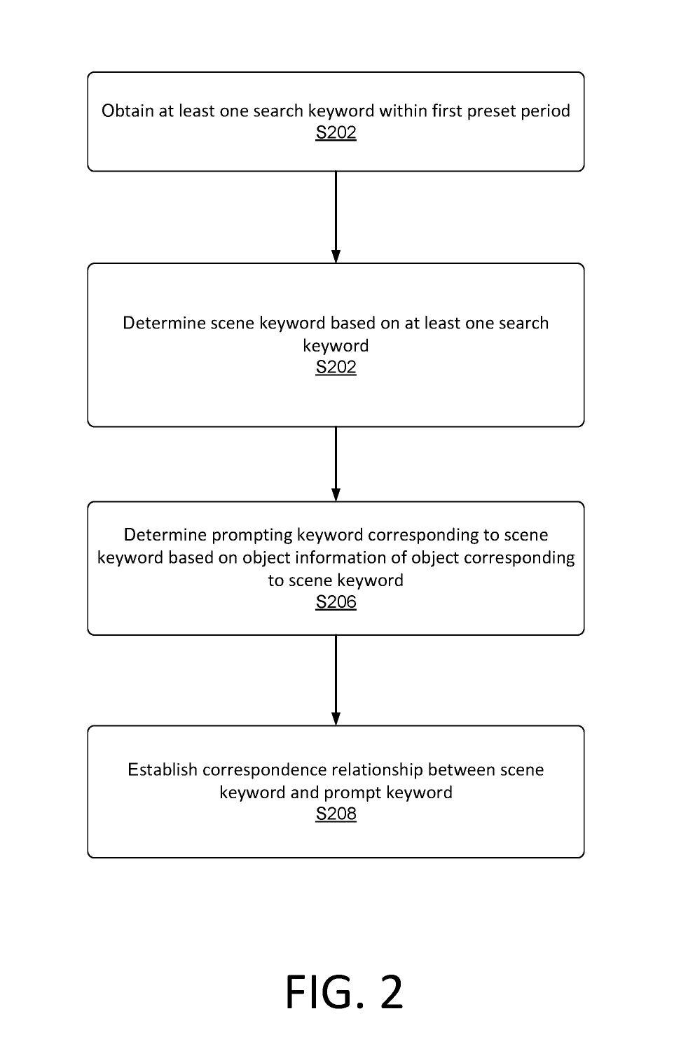

FIG. 2 is a flowchart illustrating a method of establishing an indexing relationship in accordance with embodiments of the present disclosure. The method may include the following operations.

At S202, a computing device (e.g., a server) may obtain at least one search keyword within a first preset period.

The search keywords are typically used to search for an object. The object may include item, pictures, audio, and video.

The first preset period may be flexibly set according to actual needs, for example, 2 years.

The search keyword may be obtained via a user interface. The user interface may include an input box, a list box, a radio check box, and a check box. For example, the user may enter the search keyword through the browser's input box. Accordingly, the server may obtain the search key input by the user within the first preset period through the input box of the browser.

At S204, the computing device may determine a scene keyword based on at least one search keyword.

The scene keyword may be used to describe an application scenario of the search keyword. For example, scenario keyword “ski equipment” may describe skiing scenes corresponding search terms such as “ski clothing,” “snowboard,” “ski pants,” or “gloves.” Further, scenario keyword “baby swimwear” may describe baby swimming scenes corresponding to search terms such as “baby swimmer,” “water temperature gauge,” or “baby soap.”

The number of scene keywords may be one or more.

In an embodiment, the server may determine the at least one scene keyword based on at least one search keyword by performing the following operations. The server may determine one or more categories corresponding to a search keyword in the at least one search keyword, calculate a number of the one or more categories corresponding to the search keyword of the at least one search keyword, select a candidate word set from the at least one search keyword based on the number of categories, and select the scene keyword from the candidate word set.

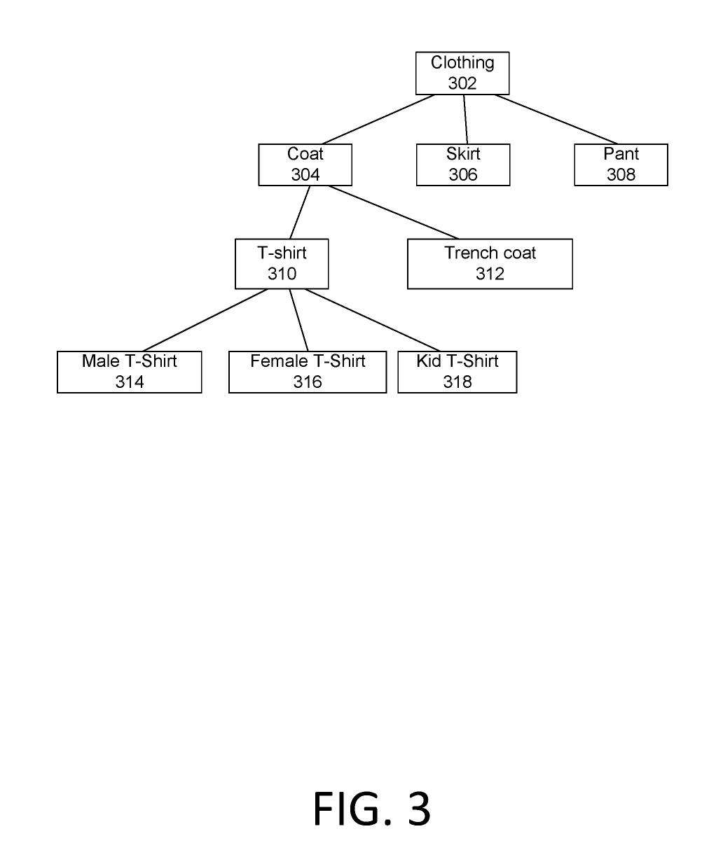

A category generally refers to a classification directory of an object. The object can be an item. Each category may correspond to one or more objects, and each object may correspond to one or more categories. FIG. 3 is a schematic diagram illustrating a category accordance with embodiments of the present disclosure. Under category “clothing” 302, there are categories “coat” 304, “skirt” 306, and “pant” 308. Under category “coat”304, there are categories “T-shirt” 310 and “trench coat” 312. Under category “T-shirt” 310, there are categories “male T-shirt” 312, “female T-shirt” 314, and “kid T-shirt” 316. In the category shown in FIG. 3, category “male T-shirt” 314 may correspond to a variety of brands or styles of male T-shirts, and round neck T-shirts for males may correspond to categories “clothing” 302. “coat” 304. “T-shirt” 310 and “male T-shirt” 314.

A search keyword may correspond to one or more objects. It is common to consider a search result of the search keyword as an object corresponding to the search keyword. For example, an e-commerce platform may search using the search keyword “outdoor” to obtain related search results. The search results may include objects “jackets”, “mountaineering bags”, “headlights”, and “compasses”. Accordingly, the objects “jackets,” “mountaineering kits,” “headlights,” and “compasses” may be used as the object of the search keyword “outdoors.” The categories of the object corresponding to the search key may be categories corresponding to the search key.

It is possible to count the number of categories corresponding to one of the at least one search keywords. Each search keyword can correspond to one or more objects, and each object can correspond to one or more categories. Accordingly, the sum of the number of categories of the respective objects corresponding to each search keyword may be considered as the number of categories corresponding to the search keywords. For example, corresponding object of search keyword “outdoor” may include “jackets”, “mountaineering”, “headlights”, and “compass”. The number of categories of the object “Jackets” corresponds is 3, the number of categories of the object “mountaineering bag” is 2, the number of categories of the object “headlights” is 1, and the number of categories of the object “compass” is 2. Accordingly, the number of categories of the search term “outdoor” may be 8.

In an embodiment, some search keywords may have a relatively large number of categories, and the meanings of these search keywords are usually broader. Some search keywords may have a relatively small number of categories, and the meanings of these search keywords are usually narrower. Accordingly, to make meanings of the identified scene keywords broader, the server may count the number of categories corresponding to each search keyword in the first preset period and then designate a set including search keywords having the number of categories greater than a predetermined first threshold as the candidate word set. The first preset threshold may be an integer greater than 0, and a specific size may be flexibly set according to actual needs.

For example, the value of the first preset threshold may be 2.The search keywords in the first preset period may include “mountain climbing,” “climbing equipment,” and “Nike basketball shoes.” The number of categories of the object “mountain climbing supplies” is 10, the number of categories of the object “mountaineering equipment” is 8, and the number of categories of the object “Nike Basketball Shoes” is 1. Accordingly, the server may use the search keywords “mountaineering supplies” and “climbing equipment” as a collection of candidate sets.

In an embodiment, the server may select the scene keyword from the candidate word set by performing word segmentation on search keywords of the candidate word set, obtain a segmented phrase corresponding to the search keyword, and select the scene keyword from the candidate word set based on the segmented phrase.

Word segmentation may refer to the process of dividing a sequence of words into one or more segmented phrases. The text sequence may include words and sentences, etc. For example, the word sequence “mountain climbing supplies” may be segmented to obtain segmented phrases including “ mountain climbing” and “supplies.”

In an embodiment, the scene keyword may be selected from the candidate word set based on the segmented phrase. The server may calculate a frequency of the segmented phrase in the candidate word set and select the scene keyword from the candidate word set based on the frequency of the segmented phrase.

In an embodiment, the server may select the scene keyword from the candidate word set based on the calculated frequency by calculating an average value of the frequencies of at least one segmented phrase corresponding to a search keyword in the candidate word set and selecting a search keyword having the average value greater than a preset second threshold from the candidate word set as the scene keyword. The first preset threshold may be an integer greater than 0, and a specific size may be flexibly set according to actual needs.

For example, the candidate word set may include 3 search keywords, which is, {“mountain climbing supplies,” “mountaineering equipment,” “bicycle supplies”}. Search keyword “mountain climbing supplies” may be segmented to obtain segmented phrases including “ mountain climbing” and “supplies.” A frequency of the segmented phrase “climbing” in the candidate word set is 2, and a frequency of the segmented phrase “supplies” in the candidate word set is 2. Accordingly, an average value of frequencies of the segmented phrase “mountain climbing” may be (2+2)/2=2.

In another embodiment, the server may select the scene keyword from the candidate word set based on the calculated frequency by calculating a median value of the frequencies of at least one segmented phrase corresponding to a search keyword in the candidate word set and selecting a search keyword having the median value greater than a preset third threshold from the candidate word set as the scene keyword. The third preset threshold may be an integer greater than 0, and a specific size may be flexibly set according to actual needs.

In an embodiment, the scene keyword may be selected from the candidate word set based on the segmented phrase. The server may determine a part of speech of the segmented phrase and select the scene keyword from the candidate word set based on the part of speech.

The segmented phrase of the search keyword may have part of speech. The part of speech of the segmented phrase may include nouns, verbs, adjectives, numerals, quantifiers, pronouns, adverbs, prepositions, conjunctions, auxiliary words, interjection, and onomatopoeia. For example, the segmented phrase “mountain climbing” may be a verb, and the segmented phrase “item” can be a noun.

For the segmented phrase of the search keyword, when the part of speech of the segmented phrase is verbs or nouns, the meaning of the search keyword may be better expressed. Accordingly, to make meanings of the identified scene keywords broader, the server may select the search keyword corresponding to segmented phrases having a verb and/or a noun in the candidate word set as the scene keyword.

For example, the candidate word set may include three search keywords, which is, {“mountain climbing supplies,” “mountaineering equipment,” “balcony washing machine”}. Search keyword “mountain climbing supplies” may segment to obtain segmented phrases including “mountain climbing” and “supplies.” The segmented phrase “mountain climbing” is a verb, and the segmented phrase “supplies” is a noun. Search keyword “mountain climbing equipment” may be segmented to obtain segmented phrases including “mountain climbing” and “equipment.” Segmented phrase “mountain climbing” is a verb, and segmented phrase “equipment” is a noun. Search keyword “balcony washing cabinet” may be segmented to obtain segmented phrases including “balcony” and “washing cabinet.” Segmented phrase “balcony” and “wash ward” are a noun. Accordingly, the server may select the search keyword corresponding to segmented phrases having a verb and a noun in the candidate word set as the scene keyword. The server may select “mountaineering equipment” and “mountain climbing supplies” as the scene keywords.

In another embodiment, the server may select the scene keyword from the candidate word set. Alternatively, the server may select M search keywords having largest numbers of corresponding categories from the candidate word set as the scene keyword. M is an integer greater than zero and less than or equal to the number of search keywords in the candidate word set, and a specific size may be flexibly set according to actual needs.

In another embodiment, the server may select the scene keyword from the candidate word set. Alternatively, the server may obtain a number of transactions and the number of queries of a search word in the candidate word set within a preset second period, calculate a transaction conversion rate corresponding to a search keyword in the candidate word set, and select the scene keyword from the candidate word set based on the transaction conversion rate. The transaction conversion rate is a ratio between the number of transactions and the number of queries of the search keyword. The value of the second preset period is generally less than or equal to the first preset period. The second preset period may be flexibly set according to actual needs.

Each object may usually be traded and has a number of transactions. For example, the object may be an item, and a user may purchase the item. Accordingly, the number of items that the user purchases may be used as the number of transactions of the item. Each search keyword may correspond to one or more objects, and each object may usually be traded. Accordingly, the sum of the number of transactions of the respective objects corresponding to each search keyword may be used as the number of transactions of the item. For example, corresponding object of search Keyword “outdoor” may include “jackets”, “mountaineering”, “headlights”, and “compass”. During the second preset period, the number of transactions for the object “Jackets” is 2, the number of transactions for the object “mountaineering bag” is 2, the number of transactions for the object “headlights” is 6, and the number of transactions for the object “compass” is 8. Accordingly, During the second preset period, the number of transactions of the search term “outdoor” may be 20.

In an embodiment, the value of the second preset period can be 1 year. In one year, the number of transactions of search term “outdoor” is 4,000, and the corresponding number of searches is 8,000. Accordingly, the transaction conversion rate of the search keyword “outdoor” is 0.5.

In an embodiment, the server may select a scene keyword from a candidate word set based on the transaction conversion rate of the search keyword by performing the following operations. The server may select N search keywords having smallest transaction conversion rates from the candidate word set as the scene keyword. N is an integer greater than 0 and less than or equal to the number of search keywords in the candidate word set. The value of N may be flexibly set according to actual needs.

In an embodiment, the server may select a scene keyword from a candidate word set based on the transaction conversion rate of the search keyword by performing the following operations. The server may select search keywords having transaction conversion rates less than a preset fourth threshold from the candidate word set as the scene keyword. The fourth preset threshold may be a real number greater than 0, and the value of the fourth preset threshold may be flexibly set according to the actual needs.

At S206, the computing device may determine a prompting keyword corresponding to the scene keyword based on an object information of an object corresponding to the scene keyword.

In an embodiment, the server may designate a set including objects corresponding to the scene keyword as a first object set. The server may select the second object from the first object set and determine a prompting keyword corresponding to the scene keyword based on the second object.

The server may select the second object from the first object set by selecting objects having numbers of transactions greater than a preset fifth threshold within a preset third period from the first object set as the second object. Alternatively, the server may select objects having numbers of being visited greater than a preset sixth threshold within a preset third period from the first object set as the second object.

The fifth preset threshold and the sixth preset threshold may be an integer greater than 0, and a specific size may be flexibly set according to actual needs.

The server may determine a prompting keyword corresponding to the scene keyword based on the second object by performing word segmentation on a name of the second object to obtain segmented phrases of the second object and selecting a core segmented phrase from the segmented phrases of the name of the second object as the prompting keyword. The core segmented phrase may indicate a meaning of the name of the second object. The number of core segmented phrase may be one or more.

For example, a name of an object can be “genuine SAHOO windproof helmet winter bike mountain bike biking equipment bicycle helmet.” The server may perform word segmentation on the name of the object to obtain segmented phrases of the name of the object: “genuine”, “SAHOO”, “windproof”, “helmet”, “winter”, “bike”, “mountain bike”, “biking equipment” and “bicycle”. The core segmented phrase “helmet” may indicate a meaning of the name of the object. Accordingly, the server may use the segmented phrase “helmet” as a prompting keyword.

It should be noted that the above-mentioned various methods of acquiring scene keywords may be used alone or in combination, those skilled in the art may choose the methods flexibly according to actual needs, and the present disclosure is not intended to be limited to this.

It should be noted that the first preset threshold, the second preset threshold, the third preset threshold, the fourth preset threshold, the fifth preset threshold, the sixth preset threshold may have the same values, different, or partially the same. The present disclosure is not intended to be limited to this.

At S208, the computing device may establish a correspondence relationship between the scene keyword and the prompting keyword.

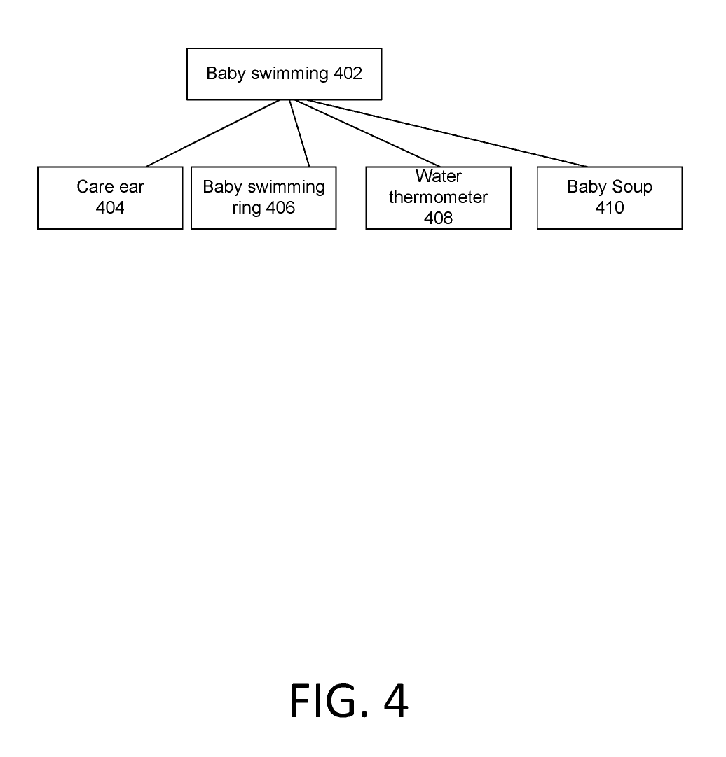

Based on the scene keyword and the prompting keyword determined based on the scene keyword, the server may establish a correspondence relationship between the scene keyword and the prompting keyword. For the correspondence relationship between the scene keyword and the prompting keyword, each scene keyword may correspond to one or more prompting keywords, and each prompting keyword may correspond to one or more scene keywords. As illustrated in FIG. 4, scene Keyword “baby swimming” 402 may correspond to prompting keywords “care ear” 404, “baby swimming ring” 406, “water thermometer” 408, and “baby soap” 410. Further, the promote keyword “glove” may correspond to scene keywords “biking equipment” and “ski equipment.”

The method described above relates to establishing an indexing relationship. The embodiments may determine a scene keyword corresponding to the search keyword based on category information of search keywords input by users, generate a prompting keyword based on object information of a related object in a scenario, and then establish a correspondence relationship between the scene keyword and the prompting keyword. The keyword may be a complete coverage of a scene associated with the object. When a user uses the index relationship to index, the embodiments herein may ensure the fullness of the generated keywords, effectively help users, and improve retrieval efficiency.

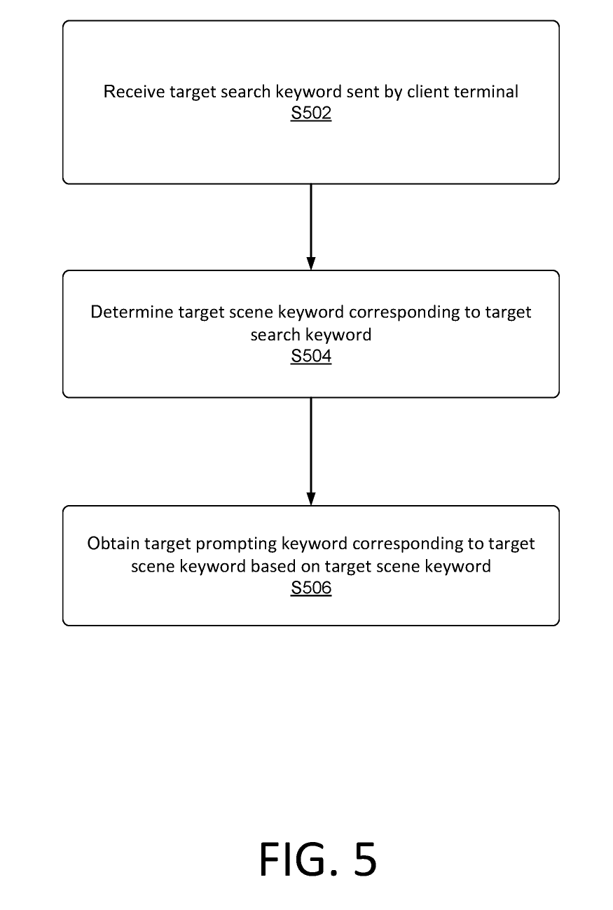

As illustrated in FIG. 5, the embodiments of the present disclosure include a method of generating a prompting keyword in the present embodiment. The method may include the following operations.

At S502, a computing device may receive a target search keyword sent by a client terminal.

The client may be a client terminal running an application program on any of the electronic devices, such as the client of a browser and the client of an instant messaging software. The electronic device may include a personal computer, a server, an industrial computer, a mobile smartphone, a tablet, a portable computer (e.g., a notebook computer, etc.), a personal digital assistant (PDA), a desktop computer, and intelligent wear equipment, etc. For example, a user may input a target keyword via a user interface. Accordingly, the client may obtain the target keyword through the interactive interface, and a server may receive the target search keyword from the client.

At S504, the computing device may determine a target scene keyword corresponding to the target search keyword. The target scene keyword may indicate an application scenario of an object corresponding to the target search keyword.

In an embodiment, the server may calculate a similarity between the target search keyword, candidate scene words in a candidate scene keyword set, and determine the target scene keyword from the candidate scene keyword set based on the calculated similarity.

In an embodiment, the server may designate a scene keyword in the candidate scene keyword set having the highest calculated similarity as the first scene keyword.

At S506, the computing device may obtain a target prompting keyword corresponding to the target scene keyword based on the target scene keyword.

In an embodiment, the server may obtain a target prompting keyword corresponding to the target scene keyword based on a correspondence between a preset scene keyword and the prompting keyword.

As illustrated in FIG. 4, scene keyword “baby swimming” 402 may correspond to prompting keywords “care ear” 404, “baby swimming ring” 406, “water thermometer” 408, and “baby soap” 410. When the target scene keyword is “baby swimming” 402, the computing device (e.g. a server) may, based on the correspondence relationship between the scene keyword and the prompting keyword, obtain one or more target prompting keywords corresponding to keyword “baby swimming” 402, which are “care ear” 404, “baby swimming ring” 406, “water thermometer” 408, and “baby soap” 410.

The server may send the target prompting keyword to the client for display.

The embodiments of the present disclosure further relate to a method of displaying web page data. The method may include the following operations.

The client may receive a target search keyword input by a user, and the client may transmit the target search keyword to the server.

The client may display web page data returned from the server. The web page data may include the target prompting keyword. The target prompting keyword corresponds to the target scene keyword. The target scene keyword may indicate an application scenario of an object corresponding to the target search keyword.

The embodiments described above provide methods for generating a prompting keyword and displaying web page data. The target scene keyword may be determined based on the target search keyword input by the user. The prompting keyword may be generated based on the correspondence between a preset scene keyword and the prompting keyword. The embodiments herein may ensure the fullness of the generated keywords, effectively help users, and improve retrieval efficiency.

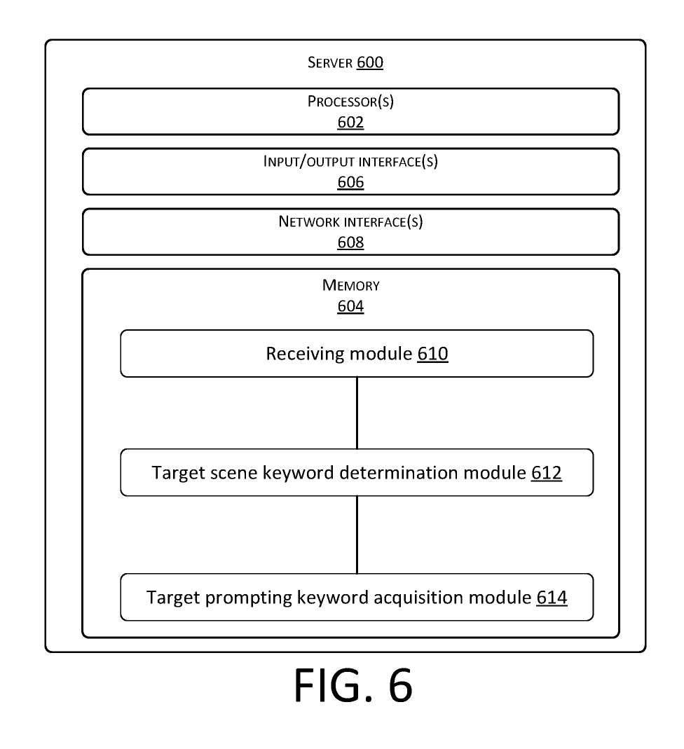

The embodiments further relate to a server. As illustrated in FIG. 6, a server 600 may include one or more processor(s) 602 or data processing unit(s) and memory 604. The server 600 may further include one or more input/output interface(s) 606 and one or more network interface(s) 608. The memory 604 is an example of computer readable media.

The computer readable media include volatile and non-volatile, removable and non-removable media, and can use any method or technology to store information. The information may be a computer readable instruction, a data structure, and a module of a program or other data. Examples of storage media of a computer include, but are not limited to, a phase change memory (PRAM), a static random access memory (SRAM), a dynamic random access memory (DRAM), other types of RAMs, an ROM, an electrically erasable programmable read-only memory (EEPROM), a flash memory or other memory technologies, a compact disk read-only memory (CD-ROM), a digital versatile disc (DVD) or other optical storage, a cassette tape, a tape disk storage or other magnetic storage devices, or any other non-transmission media, which can be that storing information accessible to a computation device. According to the definition herein, the computer readable media does not include transitory computer readable media (transitory media), for example, a modulated data signal and a carrier.

The memory 604 may store therein a plurality of modules or units including: a receiving module 610, a target scene keyword determination module 612, and a target prompting keyword acquisition module 614.

The receiving module 610 is configured to receive a target search keyword sent by a client terminal. The target scene keyword determination module 612 is configured to determine a target scene keyword corresponding to the target search keyword. The target scene keyword may indicate an application scenario of an object corresponding to the target search keyword.

The target prompting keyword acquisition module 614 is configured to obtain a target prompting keyword corresponding to the target scene keyword based on the target scene keyword.

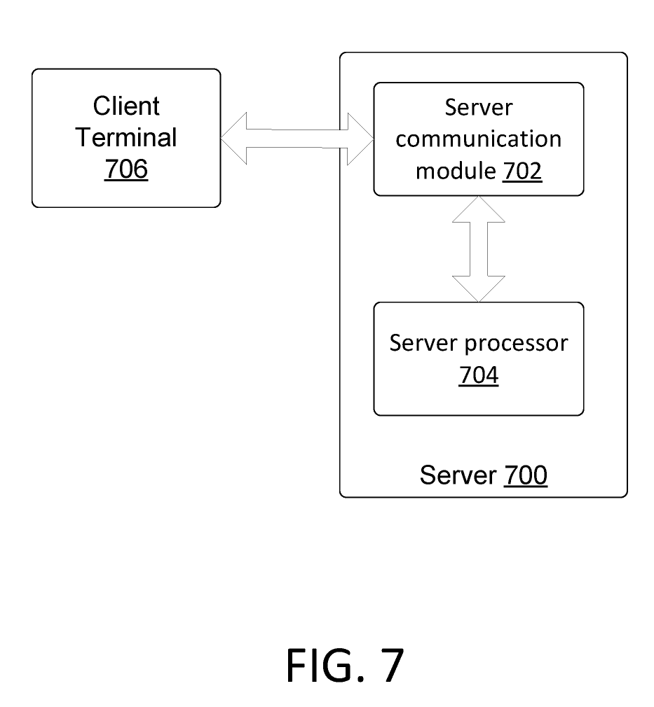

The embodiments further relate to a server. As illustrated in FIG. 7, the server 700 may include a server communication module 702 and a server processor 704 and communicate with a client terminal 706.

The server communication module 702 is configured to perform network data communication. The server communication module 702 may be configured in accordance with the TCP/IP protocol and communicate under the protocol.

In one embodiment, the server communication module 702 may be a wireless mobile network communication chip, such as GSM, CDMA, etc., a WIFI chip, or a Bluetooth chip.

The server processor 704 is configured to receive, via the server communication module 702, the target search keyword transmitted by the client, determine a target scene keyword corresponding to the target search keyword, and obtain a target prompting keyword corresponding to the target scene keyword based on the target scene keyword. The target scene keyword may indicate an application scenario of an object corresponding to the target search keyword.

In one embodiment, the server processor 704 may be implemented in any suitable manner. For example, the server processor 704 can be implemented using a microprocessor or processor and the memory such as (micro) computer readable program code executed by a processor (e.g., software or firmware), computer readable medium, logic gates, switches, an application specific integrated circuit (ASIC), programmable logic controllers and embedded microcontroller form. The present disclosure is not intended to be limited to this.

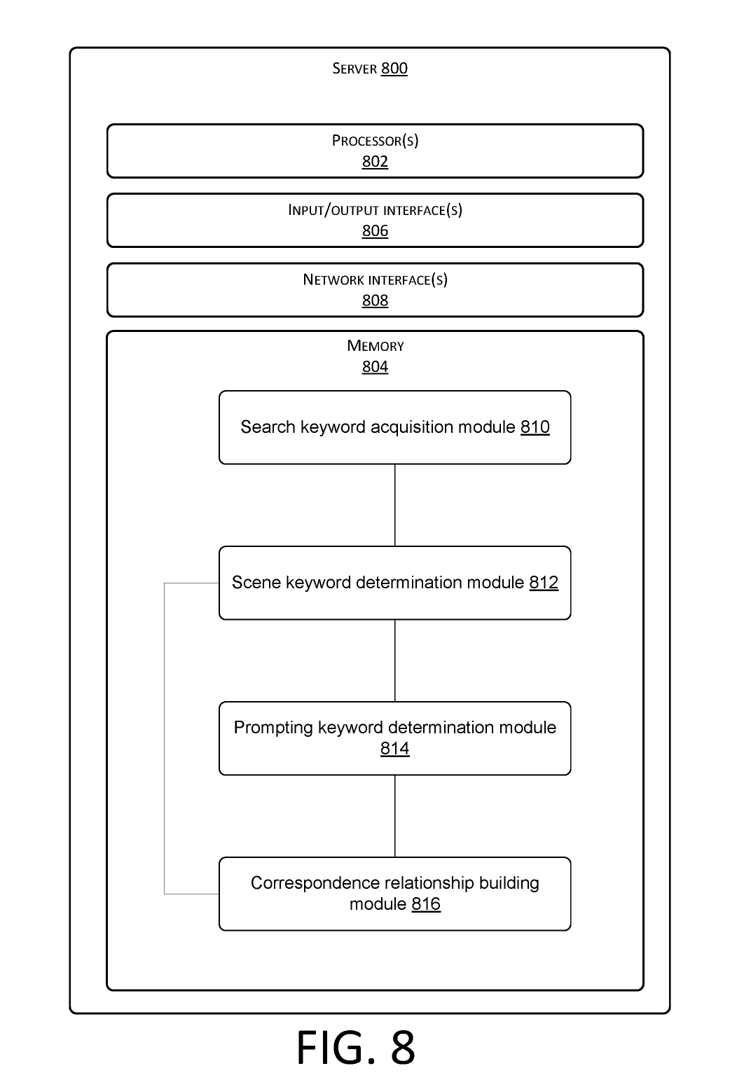

The implementations further relate to a server. As illustrated in FIG. 8, the server 800 may include one or more processor(s) 802 or data processing unit(s) and memory 804. The server 800 may further include one or more input/output interface(s) 806 and one or more network interface(s) 808. The memory 804 is an example of computer readable media.

The memory 804 may store therein a plurality of modules or units including: a search keyword acquisition module 810, a scene keyword determination module 812, a prompting keyword determination module 814, and a correspondence relationship building module 816.

The search keyword acquisition module 810 is configured to obtain at least one search keyword within a first preset period.

The scene keyword determination module 812 is configured to determine a scene keyword based on at least one search keyword.

The prompting keyword determination module 814 is configured to determine a prompting keyword corresponding to the scene keyword based on an object information of an object corresponding to the scene keyword.

The corresponding relationship building module 804 is configured to establish a correspondence relationship between the scene keyword and the prompting keyword.

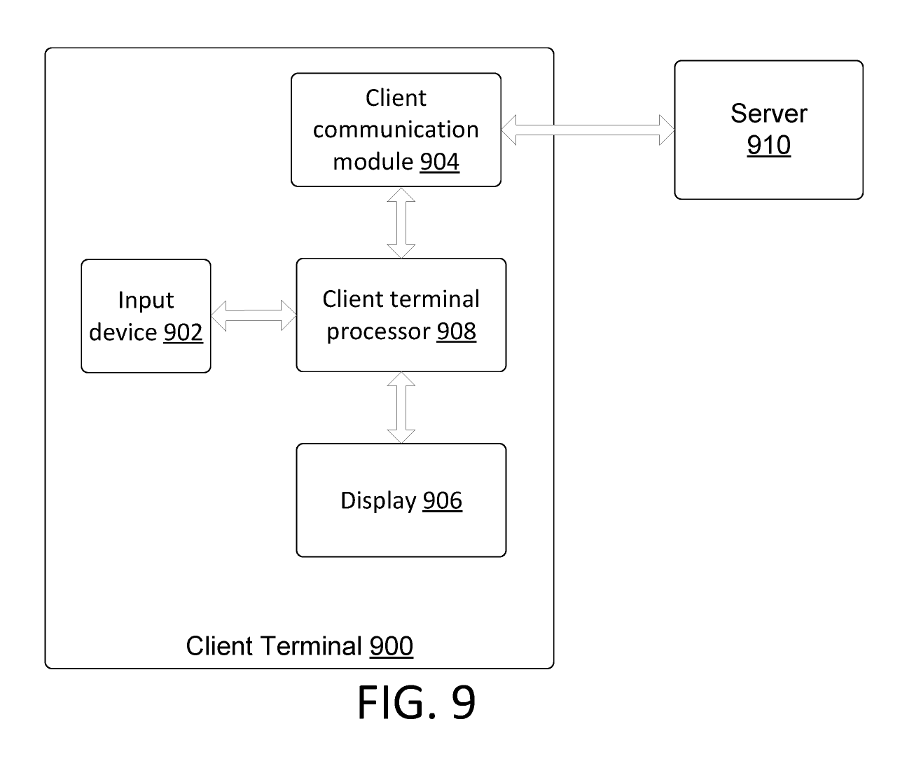

The embodiments further relate to a client terminal. As illustrated in FIG. 9, a client terminal 900 may include an input device 902, a client communication module 904, a display 906, and a client processor 908. The client terminal 900 communicate with a server 910.

The input device 902 is configured to input data. The input device 902 may be a device that interacts with a computer or a person. In one embodiment, the input device 902 may be a keyboard, a mouse, a camera, a scanner, a light pen, a handwriting tablet, etc.

The client communication module 904 is configured to communicate network data. The client communication module 904 may be configured in accordance with the TCP/IP protocol and communicate under the protocol. In one embodiment, the client communication module 904 may specifically be a wireless mobile network communication chip, such as GSM, CDMA, etc., a WIFI chip, or a Bluetooth chip.

The display 906 is configured to display data. The display 906 is a display tool that displays an electronic file through a specific transmission device to a screen and then to human eyes. In one embodiment, the display 906 may be a cathode ray tube display (CRT), a plasma display (PDP), a liquid crystal display (LCD), a LED display, or a 3D display.

The client processor 908 is configured to receive a target search keyword input by a user via an input device. The client communication module 904 may transmit the target search keyword to a server. The client communication module 904 may receive the web page data returned from the server and control the web page data displayed on the monitor. The web page data may include a target prompting keyword, and the target prompting keyword corresponds to the target scene keyword. The target scene keyword indicating an application scenario of an object corresponding to the target search keyword.

In one embodiment, the client processor 908 may be implemented in any suitable manner. For example, the client processor 908 may be implemented using a microprocessor or processor and the memory such as (micro) computer readable program code executed by a processor (e.g., software or firmware), computer readable medium, logic gates, switches, an application specific integrated circuit (ASIC), programmable logic controllers and embedded microcontroller form. The present disclosure is not intended to be limited to this.

For the client and server disclosed in the above embodiments, the specific functions performed therein may be explained in contrast to the method embodiments of the present application to achieve technical effects of the method embodiments.

It should be noted that the server in the embodiment of the present application may be a standalone server or a server cluster for implementing a function, and the present disclosure is not intended to be limited to this.

In the 1990s, a technical improvement may be clearly differentiated by hardware improvements (for example, improvement of circuit structures such as diodes, transistors, switches, etc.) or software improvements (improvements to the method flow). However, with the development of technology, many of today's process improvements have been a direct improvement in hardware circuit architectures. Designers may incorporate improved methods to hardware circuits to get the corresponding hardware circuit structures. Accordingly, a method of process improvement may be achieved with hardware entity modules. For example, a programmable logic device (PLD) (e.g., Field Programmable Gate Array, (FPGA)) is one such integrated circuit logic functions performed and determined by a user to program the device. Programmed by the designer, a digital system is “integrated” in PLD without manufacturers designs and productions of specialized integrated circuit chip 2. Now, replacing manually produced integrated circuit chip, this program is also mostly replaced by “logic compiler software. Similar to software compiler, such logic compiler compiles the original codes written in a specific programming language. This is called a hardware description language (HDL). HDL is not the only one, and there are many kinds, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, Ruby Hardware Description Language (RHDL), etc. The most common ones are Very-High-Speed Integrated Circuit Hardware Description Language (VHDL) and Verilog2. Skilled in the art should be clear that a logic method flow may be achieved in hardware circuits by using the several methods of hardware description language, performing a little logic programming, and compiling into an integrated circuit.

Skilled in the art also know that there are other methods implementing processors in addition to pure computer readable program code. The methods may be used to control logic gates, switches, in the form of application specific integrated circuits, programmable logic controllers, and embedded microcontrollers. Therefore, the processors may be a hardware component, include modules for implementing various functions and are considered as a part of hardware structures. Therefore, a system or apparatus may be considered as software modules and/or hardware structures.

Systems, apparatuses, modules or units of the above-described embodiments set forth herein may be implemented by a computer chip or entity.

In some implementations, for the convenience of description, the description of the devices and/or functions are divided into various units. Of course, the functions of the units can be implemented in one or more of the same software and/or hardware.

As it can be seen from the above implementations, it is apparent to those skilled in the art that the present application may be implemented by means of software plus a generic hardware platform. Based on this understanding, the technical solution of the present disclosure may be embodied in the form of a software product, either essentially or in the form of a prior art. The computer software product may be stored in a storage medium, such as ROM/RAM, disk, CD, etc., including a number of instructions to enable a computer device (which may be a personal computer, a server, or a network device, etc. to perform the embodiments of the present application.

This specification and each of the above embodiments is described using a progressive manner, the same or similar parts of the various embodiments can be references to each other, and each embodiment focuses on the differences from other embodiments. In particular, for a system embodiment, since it is substantially similar to the method embodiment, the description is relatively simple by referring to the part of the method embodiment of the instructions.

The embodiments of the present disclosure may be used in a number of general purposes or special computer system environments or configurations, for example, a personal computer, a server computer, a handheld device or a portable device, a flatbed device, a multiprocessor system, a microprocessor-based system, a set top box, a programmable consumer electronics device, a network PC, a small computer, a large computer, a system or device distributed computing environment and so on.

The present application may be described in the general context of computer-executable instructions executed by a computer, such as program modules. In general, program modules include routines, programs, objects, components, and data structures that perform specific tasks or implement specific abstract data types. The embodiments of the present disclosure may also be implemented in a distributed computing environment. In these distributed computing environments, tasks are performed by a remote processing device connected via a communication network. In a distributed computing environment, the program modules may be located in local and remote computer storage media including storage devices.

While the present disclosure has been described by way of examples, one of ordinary skill in the art knows that variations of the present disclosure are made without departing from the spirit of the present disclosure, and the appended claims include variations without departing from the spirit of the present disclosure.

What is claimed is:

1. A method comprising:
receiving a target search keyword;
determining a target scene keyword corresponding to the target search keyword, the target scene keyword indicating an application scenario of an object corresponding to the target search keyword; and
obtaining a target prompting keyword corresponding to the target scene keyword based on the target scene keyword.

2. The method of claim 1, wherein the determining the target scene keyword corresponding to the target search keyword includes:
calculating a similarity between the target search keyword and one or more candidate scene words in a candidate scene keyword set; and
determining the target scene keyword from the candidate scene keyword set based on the calculated similarity.

3. The method of claim 2, wherein the determining the target scene keyword from the candidate scene keyword set based on the calculated similarity includes designating a scene keyword in the candidate scene keyword set having the highest calculated similarity as the target scene keyword.

4. The method of claim 2, wherein the obtaining the target prompting keyword corresponding to the target scene keyword includes obtaining the target prompting keyword corresponding to the target scene keyword based on a correspondence relationship between a preset scene keyword and the target prompting keyword.

5. A method comprising:
obtaining at least one search keyword within a first preset time period;
determining a scene keyword based on the at least one search keyword;
determining a prompting keyword corresponding to the scene keyword based on an object information of an object corresponding to the scene keyword; and
establishing a correspondence relationship between the scene keyword and the prompting keyword.

6. The method of claim 5, wherein the determining the scene keyword based on the at least one search keyword comprises:
determining one or more categories corresponding to a search keyword in the at least one search keyword;
calculating a number of the one or more categories corresponding to the search keyword of the at least one search keyword; and
selecting a candidate word set from the at least one search keyword based on the number of the one or more categories; and
selecting the scene keyword from the candidate word set.

7. The method of claim 6, wherein the selecting the candidate word set from the at least one search keyword includes grouping at least one search keyword having the number of categories greater than a predetermined first threshold into the candidate word set.

8. The method of claim 6, wherein the selecting the scene keyword from the candidate word set includes:
performing word segmentation on search keywords of the candidate word set;
obtaining one or more segmented phrases corresponding to the search keywords; and
selecting the scene keyword from the candidate word set based on the one or more segmented phrases.

9. The method of claim 8, wherein the selecting the scene keyword from the candidate word set based on the one or more segmented phrases comprises:
calculating a frequency of the one or more segmented phrases in the candidate word set respectively; and
selecting the scene keyword from the candidate word set based on the calculated frequency.

10. The method of claim 9, wherein the selecting the scene keyword from the candidate word set based on the calculated frequency includes:
calculating an average value of frequencies of the one or more segmented phrases corresponding to one or more search keywords in the candidate word set, and
selecting the search keyword having the average value greater than a preset second threshold from the candidate word set as the scene keyword.

11. The method of claim 9, wherein the selecting the scene keyword from the candidate word set based on the calculated frequency includes:
calculating a median value of frequencies of the one or more segmented phrases corresponding to one or more search keywords in the candidate word set, and
selecting the search keyword having the median value greater than a preset third threshold from the candidate word set as the scene keyword.

12. The method of claim 9, wherein the selecting the scene keyword from the candidate word set based on the one or more segmented phrases includes:
determining a part of speech of the one or more segmented phrases respectively; and
selecting the scene keyword from the candidate word set based on the part of speech.

13. The method of claim 12, wherein the selecting the scene keyword from the candidate word set based on the part of speech includes selecting the search keyword corresponding to a segmented phrase having a verb or a noun from the candidate word set as the scene keyword.

14. The method of claim 6, wherein the selecting the scene keyword from the candidate word set includes selecting M search keywords having largest numbers of corresponding categories from the candidate word set as the scene keywords, M being a preset integer greater than zero.

15. The method of claim 6, wherein the selecting the scene keyword from the candidate word set includes:
obtaining the number of transactions and the number of queries corresponding to a respective search keyword in the candidate word set within a preset second time; and
calculating a transaction conversion rate corresponding to the respective search keyword in the candidate word set, the transaction conversion rate being a ratio between the number of transactions and the number of queries corresponding to the respective search keyword; and
selecting the scene keyword from the candidate word set based on the transaction conversion rate.

16. The method of claim 15, wherein the selecting the scene keyword from the candidate word set based on the transaction conversion rate includes selecting N search keywords having smallest transaction conversion rates from the candidate word set as the scene keywords, N being a preset integer greater than 0.

17. The method of claim 15, wherein the selecting the scene keyword from the candidate word set based on the transaction conversion rate includes selecting the search keyword having the transaction conversion rate less than a preset fourth threshold from the candidate word set as the scene keyword.

18. The method of claim 5, wherein the determining the prompting keyword corresponding to the scene keyword based on the object information of the object corresponding to the scene keyword includes:
grouping objects corresponding to the scene keyword into a first object set;
selecting a second object from the first object set; and
determining the prompting keyword corresponding to the scene keyword based on the second object.

19. The method of claim 18, wherein the selecting the second object from the first object set includes:
selecting objects having the number of transactions greater than a preset fifth threshold within a preset third time from the first object set as the second object; or
selecting objects having the number of being visited greater than a preset sixth threshold within a preset third time from the first object set as the second object.

20. A method comprising:
receiving a target search keyword;
transmitting the target search keyword to a server; and
displaying web page data returned from the server, the web page data including a target prompting keyword, the target prompting keyword corresponding to a target scene keyword, the target scene keyword indicating an application scenario of an object corresponding to the target search keyword.
